(19) United States
(12) Patent Application Publication
(10) Pub. No.: US 2024/0020553 A1
(43) Pub. Date: Jan. 18, 2024

(54) INTERACTIVE ELECTRONIC DEVICE FOR PERFORMING FUNCTIONS OF PROVIDING RESPONSES TO QUESTIONS FROM USERS AND REAL-TIME CONVERSATION WITH THE USERS USING MODELS LEARNED BY DEEP LEARNING TECHNIQUE AND OPERATING METHOD THEREOF

(71) Applicant: Yonghyun Kwon, Seoul (KR)

(72) Inventor: Yonghyun Kwon, Seoul (KR)

(21) Appl. No.: 18/116,303

(22) Filed: Mar. 2, 2023

(30) Foreign Application Priority Data
Jul. 15, 2022 (KR) 10-2022-0087821

(51) Int. Cl. G06N 5/04; G06N 3/092

(52) U.S. Cl. CPC G06N 5/04; G06N 3/092

(57) ABSTRACT

An interactive electronic device trained by a deep learning technique according to various embodiments herein may comprise: a memory; a communication module; an input means; an output means; and a processor configured to control the memory, the communication module, the input means, and the output means by using a model trained by the deep learning technique. The present invention is to allow a response robot trained by an expert group only with basic knowledge to crawl necessary information by itself or appropriately provide information required by a user through customer (user) consultation or questionnaire.

### CROSS-REFERENCE TO RELATED APPLICATION

This application claims priority to and the benefit of Korean Patent Application No. 10-2022-0087821, filed on Jul. 15, 2022, the disclosure of which is incorporated herein by reference in its entirety.

### BACKGROUND

### Technical Field

The present invention relates to the field of robot technology in the field of artificial intelligence technology, and more particularly, to an interactive electronic device or a robot, which is learned using deep learning to perform dialog with a user, and a method for operating the same.

### Background Technology of the Invention

Recently, with the development of artificial intelligence technology according to the artificial intelligence craze, many companies are trying to enter the era of artificial intelligence by manufacturing an interactive electronic device or a robot that intends to provide an appropriate response or information according to a user's question or utterance in order to satisfy various requirements such as customer service, marketing, and guidance. Since the above-described interactive electronic device or robot may communicate with a user through conversation or sign language, it is possible to respond to a question or conversation of a customer.

For example, in relation to the field of education, a parent or a child may be provided with materials or information for building a career, appropriate information useful for a business of an individual business operator, and the like in a timely manner or may request the same as questions, and the above-described interactive electronic device or robot may provide an appropriate response and solution thereto.

However, in order to actually implement the above-described electronic device or robot, the developer needs to have many questions or responses in order to respond all the questions of the user in various fields and various topics. Therefore, when the developer builds the response robot, there is a disadvantage that a large amount of labor costs must be consumed.

### SUMMARY

### Technical Problem

The present invention has been made in an effort to solve the above-described problems, and an object of the present invention is to allow a response robot trained by an expert group only with basic knowledge to crawl necessary information by itself or appropriately provide information required by a user through customer (user) consultation or questionnaire.

### Means for Solving Problem

An interactive electronic device using artificial intelligence according to various embodiments of the present disclosure includes: a memory; a communication module; and a processor based on a model trained by a deep learning technique, wherein the processor is configured to: determine whether a user can respond to an utterance by inputting the utterance from the user to a response possible determination model stored in the memory, generate a response to the utterance by inputting the determination result to a response model stored in the memory when the user can respond to request information, collect information associated with the request information of the user by inputting the determination result to a crawling model stored in the memory when the user cannot respond to the request information, collect information associated with the request information of the user by collecting information associated with the request information of the user, determine whether the user can respond to the utterance after collecting information associated with the request information of the user, generate a response to the utterance by inputting the determination result to a response model stored in the memory and outputting the generated response through an output means when the user can respond to the request information, collect information associated with the request information of the user by performing a questionnaire on the user to collect information associated with the request information of the user from a questionnaire when the user cannot respond to the request information, The determining model building steps may include a step of: obtaining request information of a user from a natural language included in an utterance of the user obtained by using an input means; and determining whether it is possible to respond to the request information of the user based on information stored in the memory.

The response possible determination model building steps may further include a step of: calculating a similarity between the user request information and information clustered and stored in the memory for each field to determine a field of the user request information; and combining information included in the memory for the determined field to determine whether to generate a response to the user request information and determine whether additional information for the field is required, wherein the crawling model is built by crawling model building steps, the crawling model building steps are executed through the processor of the electronic device, and the crawling model building steps may further include: accessing the Internet through a network and collecting the additional information when the additional information is required; comparing the collected additional information with information stored in the memory to calculate a reliability parameter for the collected additional information; calculating a weight for each of the collected additional information and the information stored in the memory based on the reliability parameter; and generating a response by adjusting an amount of the collected additional information and the information stored in the memory according to a magnitude of the weight for each information.

The model may be periodically evaluated, may perform reinforcement learning, and may perform map learning using basic pattern data, wherein the response possible determination model may include a step of: comparing the collected additional information with information obtained through the reinforcement learning and the map learning and clustered and stored in the memory; calculating a reliability parameter of the collected additional information according to a result of the comparison; and determining whether to store the collected additional information in the memory according to the calculated reliability parameter.

The response model may be built by response model building steps, the response model building steps may be executed through the processor of the electronic device, and the determination model building steps may include a step of: calculating an accuracy parameter indicating an accuracy of a response generated for the request information of the user; when the accuracy parameter is equal to or greater than a threshold value, converting the response into a natural language and outputting the natural language through an output means; and when the accuracy parameter is less than the threshold value, accessing the Internet through a network using a crawling model and collecting additional information.

The crawling model may be built by crawling model building steps, the crawling model building steps being executed through the processor of the electronic device, and the crawling model building steps may further include: checking whether a cost is incurred in acquiring the additional information; determining whether to pay the cost on the basis of the cost, the amount of the additional information, and whether the additional information can be acquired from the Internet through a network without the cost; and acquiring the additional information by performing payment when it is determined to pay the cost.

The response model building step may further include a step of: detecting a motion of the user and a facial expression using the image sensor, obtaining context information based on the motion of the user and the facial expression, generating question information for inducing request information of the user based on the obtained context information, converting a machine language corresponding to a question to be provided to the user into a natural language using the generated question information, and outputting the converted natural language using an output means.

The building of the response model may include a step of: outputting a response to the user using an output means based on the context information and the request information, receiving an additional utterance from the user through an input means and detecting a motion of the user and a facial expression through the image sensor, generating a predictive response for predicting information expected to be required by the user based on information included in the received additional utterance and context information obtained from the motion of the user and the facial expression, and outputting the predictive response through the output means.

The building of the response model may further include a step of: sensing a motion of the user and a facial expression with respect to the additional utterance through an image sensor, acquiring an image of the sensed motion of the user and facial expression, determining an emotion of the user by comparing the acquired image with images clustered for each emotion of the user stored in the memory, and calculating an appropriateness parameter indicating appropriateness of the additional utterance using the determined emotion, performing an additional dialog with respect to the additional utterance when the calculated appropriateness parameter is equal to or greater than a preset threshold value, and stopping the additional utterance when the calculated appropriateness parameter is less than the preset threshold value.

A method for operating an interactive electronic device learned by a deep learning technique may include the steps of: inputting an utterance from a user to a response possible determination model stored in a memory to determine whether it is possible to respond to the utterance of the user; when it is possible to respond to the request information of the user, inputting the determination result to a response model stored in the memory, generating a response to the utterance, and outputting the response through an output means; when it is impossible to respond to the request information of the user, inputting the determination result to a crawling model stored in the memory and collecting information related to the request information of the user; after collecting the information related to the request information of the user, determining whether it is possible to respond to the user's utterance; when it is possible to respond to the request information of the user, inputting the determination result to a response model stored in the memory, generating a response to the utterance, and outputting the response through an output means; when it is impossible to respond to the request information of the user, conducting a survey to the user and collecting the information related to the request information of the user from the survey; after collecting information related to user request information from a survey by performing a survey on the user, determining whether it is possible to respond to the user's utterance; when it is possible to respond to the user request information, inputting the determination result to a response model stored in the memory, generating a response to the utterance, and outputting the response through an output means; when it is not possible to respond to the request information of the user, transmitting information associated with the request information of the user to an expert terminal to collect response information; inputting the collected information to the response model to generate a response and outputting the response through an output means; and inputting the collected information to the response model to generate a response and outputting the response through an output means, wherein the response possible determination model is built by response possible determination model building steps, the response possible determination model building steps are executed through the processor of the electronic device, and the response possible determination model building steps include: obtaining the request information of the user from a natural language included in an utterance of the user obtained by using an input means; and determining whether it is possible to respond to the request information of the user based on information stored in the memory.

### BRIEF DESCRIPTION OF THE DRAWINGS

FIG. 1 is a diagram illustrating a system for providing an interactive electronic device learned by a deep learning technique according to various embodiments of the present application.

FIG. 2 is a block diagram illustrating a configuration of an interactive electronic device learned by a deep learning technique according to various embodiments of the present disclosure.

FIG. 3 is a diagram for describing a network function according to various embodiments of the present disclosure.

FIG. 4 is a flowchart illustrating a procedure and a method for collecting additional information through the Internet because a timely and appropriate response to an utterance of a user 101 who operates an interactive electronic device learned by a deep learning technique is impossible according to various embodiments of the present disclosure.

FIG. 5 is a flowchart illustrating a response possible determination model module building step according to various embodiments of the present invention.

FIG. 6 is a flowchart illustrating a response model module building step according to various embodiments of the present invention.

The above drawings are provided by way of example so that the spirit of the present invention may be sufficiently transferred to those skilled in the art.

Accordingly, the present invention is not limited to the drawings presented below and may be embodied in other forms.

In addition, the same reference numerals throughout the specification denote the same elements.

In addition, it should be noted that a specific portion is enlarged or reduced without being proportional to the scale in the drawings so as to help understanding.

### DETAILED DESCRIPTION

Various embodiments are now described with reference to the drawings. In this specification, various descriptions are presented to provide understanding of the present disclosure. However, it is apparent that these embodiments may be practiced without this specific description.

The terms “component”, “module”, “system,” etc., as used herein, refer to a computer-related entity, hardware, firmware, software, a combination of software and hardware, or the execution of software. For example, a component may be, but is not limited to, a procedure executed on a processor, a processor, an object, an execution thread, a program, and/or a computer. For example, both an application executed in the electronic device and the electronic device may be components. One or more components may reside within the processor and/or execution thread. One component can be localized within Hanna's computer. One component may be distributed between two or more computers. Further, such components may execute from a variety of computer-readable media having various data structures stored therein. The components may communicate via local and/or remote processing according to a signal (e.g., data transmitted via another system and a network such as the Internet via a data and/or signal from one component interacting with another component in a local system, distributed system, etc.) having one or more data packets, for example.

In addition, the term “or” is intended to mean an implicit “or”, not an exclusive “or”. That is, when not otherwise specified or when not clear in the context, “X uses A or B” is intended to mean one of the natural nested substitutions. That is, if X uses A; X uses B; or X uses both A and B, “X uses A or B” may be applied in either of these cases. Further, it should be understood that the term “and/or” as used herein refers to and includes all possible combinations of one or more of the listed related items.

In addition, the terms “include” and/or “including” should be understood to mean that the corresponding features and/or components exist. However, it should be understood that the terms “include” and/or “including” do not exclude the presence or addition of one or more other features, components, and/or groups thereof. In addition, in the case where it is not otherwise specified or it is not clear in the context to indicate a singular form, it should be interpreted in this specification and claims that a singular number generally means “one or more”.

Also, the term “at least one of A or B” should be interpreted to mean “including only A”, “including only B”, and “combined with the configurations of A and B”.

Those skilled in the art should further appreciate that the various illustrative logical blocks, configurations, modules, circuits, means, logics, and algorithm steps described in connection with the embodiments disclosed herein can be implemented in electronic hardware, computer software, or combinations of both. To clearly illustrate the interchangeability of hardware and software, various illustrative components, blocks, configurations, means, logics, modules, circuits, and steps have been described above generally in terms of their functionality. Whether such functionality is implemented in hardware or software depends on the specific application and design limitations imposed on the overall system. Skilled artisans may implement the described functionality in various ways for each particular application. However, decisions of such implementation should not be construed as deviating from the scope of the present disclosure.

The description of the presented embodiments is provided so that a person having ordinary skill in the art of the present disclosure may use or practice the present invention. Various modifications to these embodiments will be apparent to those of ordinary skill in the art. The general principles defined herein may be applied to other embodiments without departing from the scope of the present application. Thus, the present invention is not limited to the embodiments presented herein. The present invention will have to be interpreted in the broadest range consistent with the principles and novel features presented herein.

Network functions, artificial neural networks, and neural networks may be used interchangeably herein.

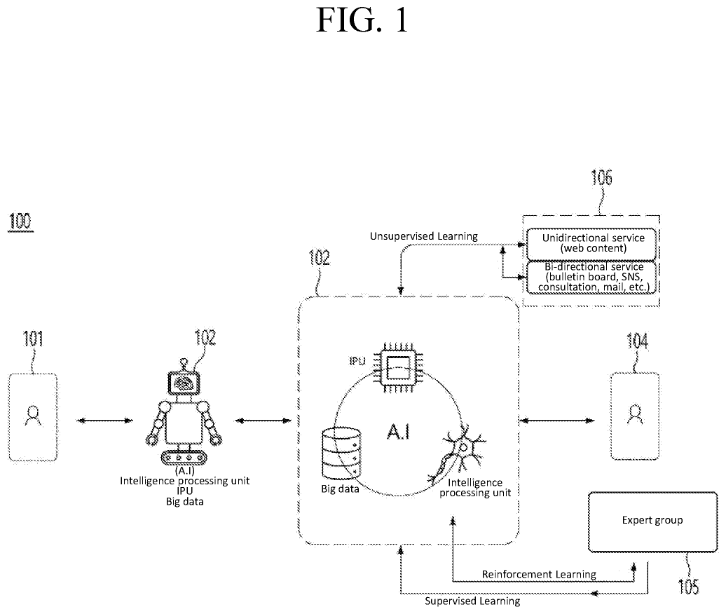

FIG. 1 is a diagram illustrating a system for providing an interactive electronic device using artificial intelligence according to various embodiments of the present invention.

A system 100 for providing an interactive electronic device using artificial intelligence according to various embodiments of the present disclosure may include a user 101, an interactive electronic device 102, an operator 104, an expert group 105, and a service provider 106 for crawling. The user 101 may be a subject that provides a question through an utterance or operation on the interactive electronic device 102. For example, the user 101 may refer to a customer who desires to use the system of the present disclosure, and may refer to users in various fields such as parents or children, teachers or students, job seekers, private business operators, and entrepreneurs. That is, the interactive electronic device 102 of the present disclosure may provide a response to a user's question using a model trained by a deep learning technique, regardless of the field. The operator 104 of the overall system 100 of the present disclosure may manage the expert group 105 and control the system provided by the interactive electronic device 102. The operator 104 generally manages the system, takes charge of supporting the interactive electronic device 102 to smoothly perform overall tasks such as approving the subscription of the user 101 and managing the user 101 by classes, and manages the user 101 by classes. The grade may be divided into, for example, paid members and free members, and the paid members may be divided into special management members and members who request bi-directional push services. The interactive electronic device 102 may provide a more active service to a member requesting a paid-member bi-directional push service than a free member, and for example, the interactive electronic device 102 may be configured to provide information on additional information to a user in a timely and timely manner, provide newly acquired information in communication to the user, and periodically update the information of the changed customer by identifying, in advance, difficult problems of the customer while collecting changed customer information by making frequent contact with the customer online.

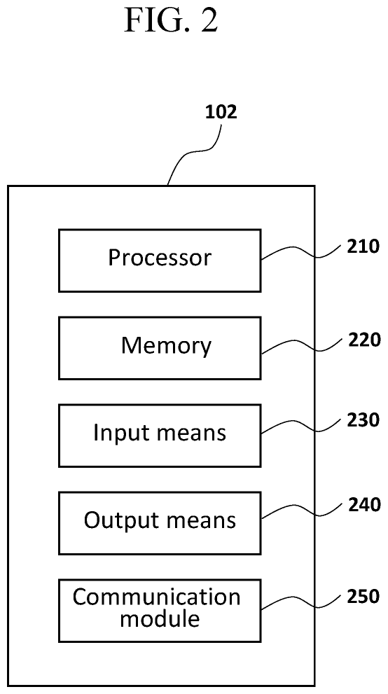

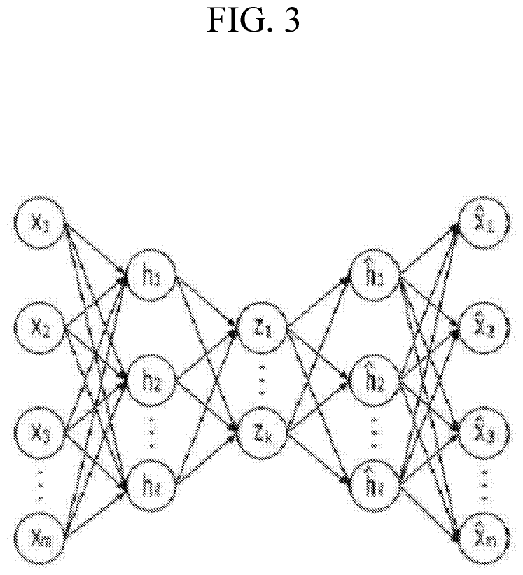

The configuration of the interactive electronic device 102 will be described in detail with reference to FIGS. 2 and 3.

FIG. 2 is a block diagram of an interactive electronic device 102 trained by a deep learning technique according to an embodiment of the present application. The configuration of the electronic device 102 illustrated in FIG. 2 is only a simplified example. In an embodiment of the present disclosure, the electronic device 102 may include other configurations for performing the computing environment of the electronic device 102, and only some of the disclosed configurations may configure the electronic device 102. The electronic device 102 may include a processor 210, a memory 220, an input means 230, an output means 240, and a communication module 250. The processor 210 may include one or more cores, and may include a processor for data analysis and deep learning, such as an intelligence processing unit (IPU), a central processing unit (CPU) of an electronic device, a general purpose graphics processing unit (GPGPU), a tensor processing unit (TPU), a neural processing unit (NPU) of a concept in which the memory 220 and the processor 210 are combined. The processor 210 may read a computer program stored in the memory and perform data processing for machine learning according to an embodiment of the present disclosure. According to an embodiment of the present disclosure, the processor 210 may perform an operation such as an image, a number, artificial intelligence, or the like for learning of the artificial neural network. The processor 210 may perform calculation for learning of a neural network, such as processing of input data for learning in deep learning (DL), feature extraction in the input data, error calculation, and weight update of the neural network using backpropagation. At least one of the IPU, the CPU, the GPGPU, the TPU, and the NPU of the processor 210 may process learning of a network function. For example, the CPU and the GPGPU may process learning of a network function and data classification using the network function together. In addition, in an embodiment of the present disclosure, the processors of the plurality of electronic devices may be used together to process the learning of the network function and the data classification using the network function. In addition, the computer program executed in the electronic device according to an embodiment of the present disclosure may be a program executable in an IPU, a CPU, an GPGPU, a TPU, an NPU, or the like.

According to an embodiment of the present disclosure, the memory 220 may store any type of information generated or determined by the processor 210 and any type of information received by the network unit. According to an embodiment of the present disclosure, the memory 220 may include at least one type of storage medium among a flash memory type, a hard disk type, a multimedia card micro type as an input means of a multimedia card, a card type memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. In addition, a next-generation new-concept convergence technology in which a processor function required for a calculation operation is added to a memory such as a high bandwidth memory-processing in memory (HBM-PIM) in which the memory 220 and the processor 210 are combined may be included. The electronic device 102 may operate in relation to a web storage that performs a storage function of the memory 220 on the Internet. The above description of the memory is only an example, and the present application is not limited thereto.

According to an embodiment of the present disclosure, the input means 230 may include various configurations capable of receiving various inputs such as a user's utterance, typing, and the like and transmitting the received inputs to the processor 210. For example, the input device may include all input tools that are apparent to those skilled in the art in a computing system, such as a voice (sound wave) input device, a keyboard, a mouse, an image input device (camera), an optical input device, a touch pad, and a biometric recognizer.

According to an embodiment of the present disclosure, the output means 230 may include various output means for providing a response to the user. For example, various output tools such as a speaker, a display, a printer, a projector, a haptic technology, a virtual reality (VR) device, and the like may be included.

The communication module 250 according to an embodiment of the present disclosure may use various wired communication systems such as a PSTN (Public Switched Telephone Network), an x Digital Subscriber Line (xDSL), a Rate Adaptive DSL (RADSL), a Multi Rate DSL (MDSL), a Very High Speed DSL (VDSL), a Universal Asymmetric DSL (UADSL), a High Bit Rate DSL (HDSL), and a Local Area Network (LAN).

The communication module 250 may use various wireless communication systems such as Code Division Multi Access (CDMA), Time Division Multi Access (TDMA), Frequency Division Multi Access (FDMA), Orthogonal Frequency Division Multi Access (OFDMA), Single Carrier-FDMA (SCFDMA), and other systems.

Herein, the communication module 250 may be configured regardless of a communication mode such as wired and wireless, and may be configured with various communication networks such as a Personal Area Network (PAN), a Wide Area Network (WAN), and the like. Also, the network may be a well-known World Wide Web (WWW), and may use a wireless transmission technology used for short-range communication such as Infrared Data Association (IrDA) or Bluetooth.

The techniques described herein may be used not only in the networks mentioned above, but also in other networks.

FIG. 3 is a schematic diagram illustrating a network function according to an embodiment of the present invention. Throughout the specification, a computation model, a neural network, a network function, and a neural network may be used as the same meaning. A neural network may be configured as a set of interconnected computation units, which may be generally referred to as nodes. These nodes may be referred to as neurons. The neural network includes at least one node. Nodes (or neurons) constituting neural networks may be interconnected by one or more links. In a neural network, one or more nodes connected through a link may relatively form a relationship between an input node and an output node. The concept of the input node and the concept of the output node are relative, and any node in an output node relationship with respect to one node may be in an input node relationship with another node, and vice versa. As described above, the relationship between the input node and the output node may be generated based on the link. One or more output nodes may be connected to one input node through a link, and vice versa. In a relationship between an input node and an output node connected through one link, data of the output node may be determined based on data input to the input node. Here, the link interconnecting the input node and the output node may have a weight. The weight may be variable, and may be variable by a user or an algorithm in order for the neural network to perform a desired function. For example, when one or more input nodes are connected to one output node by each link, the output node may determine an output node value based on values input to input nodes connected to the output node and a weight set to a link corresponding to each input node. As described above, in the neural network, one or more nodes are interconnected through one or more links to form a relationship between an input node and an output node in the neural network. The characteristics of the neural network may be determined according to the number of nodes and links in the neural network, the correlation between the nodes and the links, and the weight value assigned to each of the links. For example, when there are two neural networks having the same number of nodes and links and different weight values of the links, the two neural networks may be recognized as being different from each other.

The neural network may be configured as a set of one or more nodes. A subset of the nodes constituting the neural network may constitute a layer. Some of the nodes constituting the neural network may constitute one layer based on distances from an initial input node. For example, a set of nodes having a distance of n from an initial input node may constitute an n-layer. The distance from the initial input node may be defined by a minimum number of links that must pass through in order to reach the node from the initial input node. However, the definition of the layer is arbitrary for explanation, and the order of the layer in the neural network may be defined by a method different from the aforementioned method. For example, the layers of the nodes may be defined by the distance from the final output node.

The initial input node may refer to one or more nodes to which data is directly input without passing through a link in a relationship with other nodes among the nodes in the neural network. Alternatively, in a relationship between one node based on a link in a neural network, the nodes may mean nodes that do not have other input nodes connected by the link. Similarly, the final output node may mean one or more nodes that do not have an output node in a relationship with other nodes among nodes in the neural network. In addition, the hidden node may refer to nodes constituting a neural network, not an initial input node and a final output node.

The neural network according to an embodiment of the present disclosure may be a neural network in which the number of nodes in an input layer is equal to the number of nodes in an output layer and the number of nodes decreases and then increases as the input layer proceeds to a hidden layer. Also, the neural network according to another embodiment of the present disclosure may be a neural network in which the number of nodes in the input layer may be smaller than the number of nodes in the output layer and the number of nodes decreases as the input layer proceeds to the hidden layer. In addition, the neural network according to still another embodiment of the present disclosure may be a neural network in which the number of nodes in the input layer is greater than the number of nodes in the output layer and the number of nodes increases as the input layer proceeds to the hidden layer. The neural network according to another embodiment of the present application may be a neural network in a combined form of the above-described neural networks.

A deep neural network (DNN) may refer to a neural network including a plurality of hidden layers in addition to an input layer and an output layer. Using deep neural networks, potential structures of data can be identified. That is, the potential structure of a picture, text, video, voice, and music (for example, which object is in the picture, what is the content and emotion of the text, what is the content and emotion of the voice, etc.) may be identified. The deep neural network may include a convolutional neural network (CNN), a recurrent neural network (RNN), an auto encoder, Generative Adversarial Networks (GAN), a restricted boltzmann machine (RBM), a deep belief network (DBN), a Q network, a U network, a Siamese network, a Generative Adversarial Network (GAN), and the like. The description of the above-described deep neural network is only an example and the present application is not limited thereto.

In an embodiment of the present disclosure, the network function may include an autoencoder. The auto encoder may be a type of artificial neural network for outputting output data similar to input data. The auto encoder may include at least one hidden layer, and an odd number of hidden layers may be disposed between input/output layers. The number of nodes of each layer may be reduced from the number of nodes of an input layer to an intermediate layer called a bottleneck layer (encoding), and then may be reduced and symmetrically expanded from the bottleneck layer to an output layer (symmetric to the input layer). The auto encoder may perform non-linear dimension reduction. The number of input layers and output layers may correspond to a dimension after pre-processing of input data. In the auto-encoder structure, the number of nodes of the hidden layer included in the encoder may decrease as the distance from the input layer increases. The number of nodes of a bottleneck layer (a layer with the smallest number of nodes located between an encoder and a decoder) may be maintained to be greater than or equal to a certain number (e.g., more than half of an input layer, etc.) since a sufficient amount of information may not be transferred when the number of nodes is too small. The neural network may be trained by at least one of supervised learning, unsupervised learning, semi-supervised learning, or reinforcement learning. The learning of the neural network may be a process of applying knowledge for the neural network to perform a specific operation to the neural network.

The neural network may be trained in a direction of minimizing an error in output. In the learning of the neural network, the learning data is repeatedly input to the neural network, errors of the output and target of the neural network with respect to the learning data are calculated, and the weights of the respective nodes of the neural network are updated by backpropagating the errors of the neural network from the output layer of the neural network toward the input layer in a direction for reducing the errors. In the case of teacher learning, learning data in which the correct response is labeled is used (that is, labeled learning data) for each learning data, and in the case of unsupervised learning, the correct response may not be labeled on each learning data. That is, for example, learning data for teacher learning related to data classification may be data in which a category is labeled on each of the learning data. The labeled training data may be input to the neural network, and an error may be calculated by comparing an output (category) of the neural network with a label of the training data. As another example, in the case of unsupervised learning about data classification, an error may be calculated by comparing the learning data, which is an input, with the neural network output. The calculated error is reversely propagated in the neural network (i.e., in the direction of the input layer from the output layer), and the connection weight of each node of each layer of the neural network may be updated according to the reverse propagation. A change amount of the connection weight of each node to be updated may be determined according to a learning rate. The calculation of the neural network for the input data and the backpropagation of the error may constitute a learning cycle (epoch). The learning rate may be differently applied according to the number of repetitions of the learning cycle of the neural network. For example, in an early stage of learning of the neural network, a high learning rate may be used to allow the neural network to quickly secure a predetermined level of performance, thereby increasing efficiency, and in a late stage of learning, a low learning rate may be used to increase accuracy.

In learning of a neural network, generally, learning data may be a subset of actual data (that is, data to be processed using the learned neural network), and thus, there may be a learning cycle in which an error for the learning data is reduced but an error for the actual data is increased. Overfitting is a phenomenon in which errors in actual data increase by learning excessively on learning data. For example, a phenomenon in which a neural network that learns a cat by seeing a yellow cat does not recognize that the neural network is the cat when seeing a cat other than the yellow cat may be a kind of overfitting. Overfitting can act as a cause of increasing machine learning algorithm errors. In order to prevent the overfitting, various optimization methods may be used. In order to prevent over-adaptation, a method of increasing learning data, regulating, dropping-out deactivating a part of a node of a network in a learning process, use of a batch normalization layer, or the like, may be applied.

According to an embodiment of the present invention, disclosed is a computer-readable medium storing a data structure. A data structure may refer to organization, management, and storage of data that enables efficient access and modification to the data. The data structure may refer to an organization of data for solving a specific problem (e.g., data retrieval, data storage, and data modification in the shortest time). A data structure may be defined as a physical or logical relationship between data elements designed to support a specific data processing function. The logical relationship between the data elements may include a connection relationship between user-defined data elements. The physical relationship between data elements may include an actual relationship between data elements physically stored in a computer-readable storage medium (e.g., a permanent storage device). Specifically, the data structure may include a set of data, a relationship between data, and a function or instruction applicable to data. Through an effectively designed data structure, the electronic device may perform an operation while using a minimum amount of resources of the electronic device. Specifically, the electronic device may increase efficiency of calculation, reading, insertion, deletion, comparison, exchange, and search through an effectively designed data structure.

The data structure may be divided into a linear data structure and a non-linear data structure according to the shape of the data structure. The linear data structure may be a structure in which only one data is connected after one data. The linear data structure may include a list, a stack, a queue, and a deck. The list may mean a series of data sets in which an order exists internally. The list may include a linked list. The linked list may be a data structure in which data is connected in such a manner that each data is connected in one line with a pointer. The pointer in the linked list may include connection information with next or previous data. The linked list may be expressed as a single linked list, a double linked list, or a circular linked list according to a form. The stack may be a data listing structure that may access data limitedly. The stack may be a linear data structure capable of processing (e.g., inserting or deleting) data at only one end of the data structure. The data stored in the stack may be a data structure (LIFO-Last in First Out) that comes out faster as the data enters later. Unlike the stack, the queue may be a data structure (FIFO-First in First Out) in which data stored later is delayed. The deck may be a data structure capable of processing data at both ends of the data structure. The nonlinear data structure may be a structure in which a plurality of data are connected after one data. The nonlinear data structure may include a graph data structure. The graph data structure may be defined by a vertex and an edge, and the edge may include a line connecting two different vertices. A graph data structure tree data structure may be included. The tree data structure may be a data structure in which a path connecting two different vertices among a plurality of vertices included in the tree is one. That is, it may be a data structure that does not form a loop in the graph data structure.

Throughout the specification, a computation model, a neural network, a network function, and a neural network may be used as the same meaning. Hereinafter, the description will be unified into a neural network. The data structure may include a neural network. The data structure including the neural network may be stored in a computer-readable medium. The data structure including the neural network may also include preprocessed data for processing by the neural network, data input into the neural network, a weight of the neural network, a hyper-parameter of the neural network, data obtained from the neural network, an activity function associated with each node or layer of the neural network, a loss function for learning of the neural network, etc. A data structure including a neural network may include any of the above-described configurations. That is, the data structure including the neural network may include all or any combination of data pre-processed for processing by the neural network, data input to the neural network, a weight of the neural network, a hyper-parameter of the neural network, data obtained from the neural network, an activity function associated with each node or layer of the neural network, a loss function for learning of the neural network, and the like. In addition to the above-described configurations, the data structure including the neural network may include any other information that determines the characteristics of the neural network. In addition, the data structure may include all types of data used or generated in the computation process of the neural network, and is not limited to the above-described matters. The computer readable medium may include a computer readable recording medium and/or a computer readable transmission medium. A neural network may be configured as a set of interconnected computation units, which may be generally referred to as nodes. These nodes may be referred to as neurons. The neural network includes at least one node.

The data structure may include data input to a neural network. A data structure including data input to a neural network may be stored in a computer-readable medium. The data input to the neural network may include learning data input in a neural network learning process and/or input data input to a neural network in which learning has been completed. The data input to the neural network may include pre-processed data and/or data to be pre-processed. The preprocessing may include a data processing process for inputting data into the neural network. Accordingly, the data structure may include data to be preprocessed and data generated by preprocessing. The above-described data structure is only an example, and the present invention is not limited thereto. The data structure may include a weight of the neural network. In this specification, a weight and a parameter may be used as the same meaning.) A data structure including a weight of a neural network may be stored in a computer-readable medium. The neural network may include a plurality of weights. The weight may be variable, and may be varied by a user or an algorithm in order for the neural network to perform a desired function. For example, when one or more input nodes are connected to one output node by each link, the output node may determine a data value output from the output node based on values input to input nodes connected to the output node and a weight set to a link corresponding to each input node. The above-described data structure is only an example, and the present disclosure is not limited thereto.

As an example and not by way of limitation, the weight may include a weight that varies in a neural network learning process and/or a weight for which neural network learning has been completed. The weight varied in the neural network learning process may include a weight at a time point when a learning cycle starts and/or a weight varied during the learning cycle. The weight for which the neural network learning is completed may include a weight for which the learning cycle is completed. Accordingly, the data structure including the weight of the neural network may include a data structure including a weight that varies in a neural network learning process and/or a weight for which neural network learning has been completed. Therefore, it is assumed that the above-described weights and/or the combination of the weights are included in the data structure including the weights of the neural network. The above-described data structure is only an example, and the present disclosure is not limited thereto.

The data structure including the weight of the neural network may be stored in a computer-readable storage medium (e.g., a memory or a hard disk) after a serialization process. The serialization may be a process of storing a data structure in the same or different electronic device, reconfiguring the data structure later, and converting the data structure into a usable form. An electronic device may serialize a data structure to transmit and receive data over a network. The data structure including the weights of the serialized neural network may be reconfigured in the same electronic device or different electronic devices through deserialization. The data structure including the weight of the neural network is not limited to serialization. Further, the data structure including the weight of the neural network may include a data structure (e.g., B-Tree, Trie, m-way search tree, AVL tree, and Red-Black Tree in a non-linear data structure) for increasing the efficiency of operation while minimally using the resources of the electronic device. The above-described matters are only examples, and the present application is not limited thereto.

The data structure may include a hyper-parameter of the neural network. The data structure including the hyper-parameter of the neural network may be stored in a computer-readable medium. The hyper-parameter may be a variable that is varied by a user of the operator 104. The hyper-parameter may include, for example, a learning rate, a cost function, the number of learning cycle iterations, weight initialization (e.g., setting a range of a weight value to be weight initialization), and the number of Hidden Unit (e.g., the number of hidden layers and the number of nodes of a hidden layer). The above-described data structure is only an example, and the present disclosure is not limited thereto.

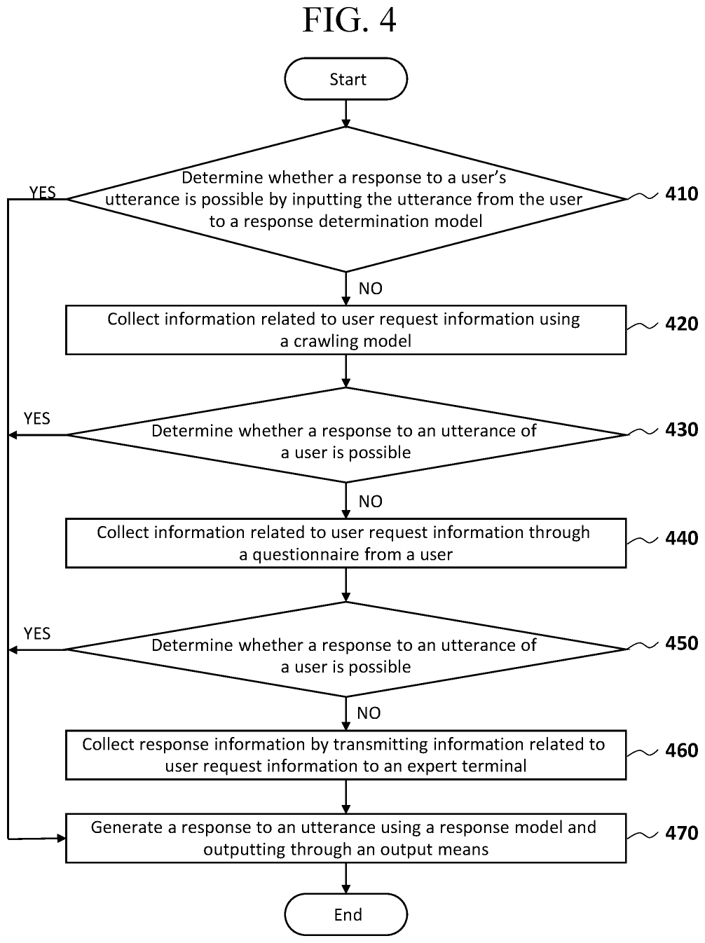

FIG. 4 is an exemplary flowchart illustrating a procedure and method for collecting additional information through the Internet because a timely and appropriate response to an utterance of a user 101 in which an electronic device operates is impossible, according to various embodiments of the present disclosure. As described above, the processor 210 may be configured to perform operations using models trained by the deep learning technique. The models described below may be supervised and learned through building steps for the corresponding model, and may be set to perform the corresponding operation when being performed by the processor 210.

In operation 410, the processor 210 may determine whether it is possible to respond to the user's utterance by inputting the utterance from the user to the response possible determination model. Before operation 410, the processor 210 may obtain the utterance from the user using the input means 230. Since communication between the user 101 and the electronic device 102 is made in a natural language, the processor 220 needs to convert the user's utterance into a machine language in order to process information. The response possible determination model is a model that is learned by a deep learning technique and stored in a memory, and may collectively refer to a model that determines whether to generate and output a response from a user's utterance. Whether a response is possible may be obvious to a person skilled in the art, such as determining whether it is possible to generate a response using information stored in the memory, or the like.

According to an embodiment, the response possible determination model may be built by response possible determination model building steps, and the response possible determination model building steps may be executed through the processor 210 of the electronic device 102. The building of the response possible determination model may include a step of: acquiring user request information from a natural language included in the user's utterance acquired using an input means, and determining whether it is possible to respond to the request information of the user 101 based on the information stored in the memory 220. The response possible determination model may determine whether it is possible to respond to the user's utterance from the utterance obtained using the input means 230 through the above steps.

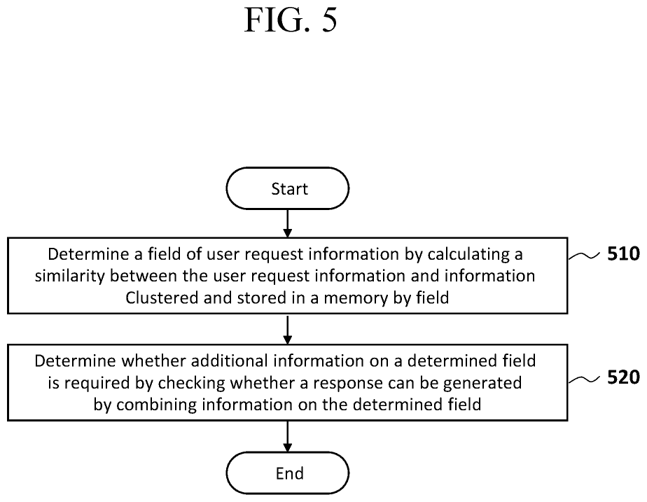

Referring to FIG. 5, the response possible determination model building steps may include the following steps.

At step 510, the processor 210 may determine a field of the user's request information by calculating a similarity between the user's request information and information clustered and stored in the memory 220 for each field. The similarity between pieces of information may be calculated based on whether pieces of information on a specific subject match each other. Information about a number of fields for responding to the user's utterance may be clustered and stored for each field in the memory 220. The user request information extracted from the user's utterance may be determined as a specific field based on the similarity, and may be determined as a plurality of fields.

At step 520, it is determined whether a response to the user request information may be generated by combining information included in the memory with respect to the determined field, and whether additional information with respect to the field is required may be determined.

Referring to FIG. 1, the electronic device 102 may perform crawling on additional information through a service provider 106. The service provider 106 may refer to a subject that provides a service on the Internet that can be connected through a network, and a range thereof is not limited. The crawling may be performed through unsupervised learning. The service provider 106 may include an unidirectional service in which the electronic device 102 may collect information in one direction through a search for web content, etc., and a bi-directional service in which the electronic device 102 may collect information through interaction with the service provider 106. Examples of the bi-directional service may include various methods such as access to a bulletin board, social network service (SNS), online consultation, and mail exchange.

When it is determined in operation 410 that a response to the user's utterance is possible, the processor 210 may generate a response to the utterance using the response model and output the response through the output means 240. For example, the processor 210 may input the determination result to the response model, generate a response to the utterance, and output the response through the output means 240. The response model is a model that is learned by a deep learning technique and stored in a memory, and may be referred to as a model that generates a response to an utterance and outputs the response through the output means 240.

When it is determined that the response to the user's utterance is impossible, in operation 420, the processor 210 may collect information associated with the user's request information using the crawling model. For example, the processor 210 may collect information associated with the request information of the user by inputting the determination result to the crawling model, and may generate a response by inputting the collected information to the response model and output the response through the output means 240. The crawling model is a model that is learned by a deep learning technique and stored in a memory, and may refer to a model that obtains information, which is to be obtained by an electronic device, by crawling the information on a network or a web.

At step 430, the processor 210 may collect information associated with the request information of the user, and then may determine whether it is possible to respond to the user's utterance using a response possible determination model. When a response to the user's utterance is possible, the processor 210 may generate a response to the utterance using the response model and output the response through an output means.

When the response to the user's utterance is not possible, at step 440, the processor 210 may collect information associated with the user's request information through the questionnaire from the user. When it is determined that the response to the user's utterance is impossible through the information collected through the crawling, the processor 210 may allow the user to proceed with the questionnaire and obtain information which may be helpful in generating the response.

At step 450, after collecting information associated with the request information of the user through the questionnaire from the user, the processor 210 may collect information associated with the request information of the user and then determine whether a response to the user's utterance is possible using a response possible determination model. After performing the questionnaire with the user, the processor 210 may determine whether a response is possible using a response possible determination model.

When it is determined that the response is impossible even after the questionnaire is conducted, at step 460, the processor 210 may collect response information by transmitting information associated with the user's request information to the expert terminal. The expert terminal may refer to a terminal of the expert group 105. That is, when it is determined that it is impossible to respond as well as the supervised learning and reinforcement learning performed in the initial stage, the information associated with the user request information may be additionally transmitted to the expert terminal of the expert group 105 to collect the response information and generate the response.

At step 470, the processor 210 may generate a response to the utterance using the response model and output the response through an output means.

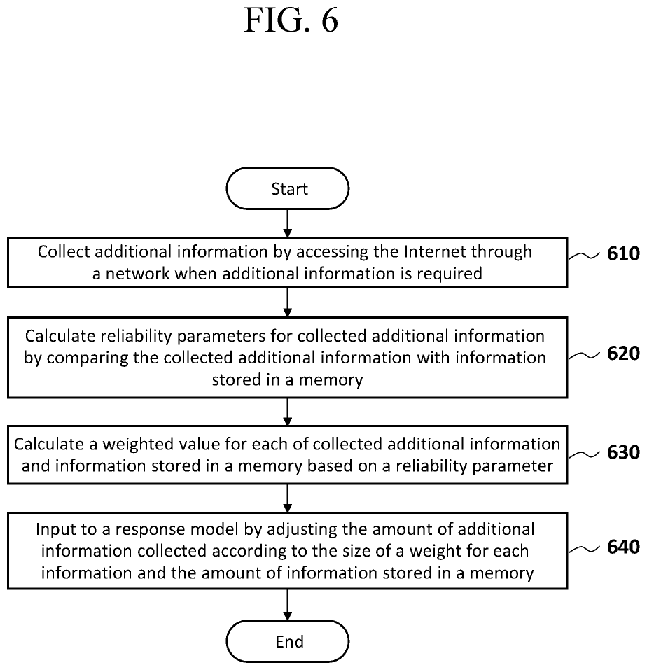

FIG. 6 is a view illustrating a methodological example for building big data based on highly reliable information by assigning a reliability parameter (weight) to unprocessed information or information obtained through crawling or real-time questionnaires and consultation through the user 101 in order to increase a probability of a correct response to a response requested by the user 101 as a response model building step according to various embodiments of the present disclosure.

At step 610, when the additional information is required, the processor 210 may access the Internet through a network and collect the additional information. The additional information may be collected through the customer, the user 101, or the service provider 106 who has subscribed to the electronic device 102 as a member, and the information may be collected in various ways through a conversation type questionnaire while providing a push server and the like to members who have subscribed to the electronic device 102 or between a counseling service with the user 101 and crawling. At step 620, the processor 210 may compare the collected additional information with the information stored in the memory to calculate a reliability parameter for the collected additional information. The reliability parameter may be determined based on a degree of coincidence between information previously stored in the memory by the processor 210 and the collected additional information. The reliability parameter may have a value of 0 to 1.

At step 630, the processor 210 may calculate a weight for each of the collected additional information and the information stored in the memory, based on the reliability parameter. At step 640, the processor 210 may adjust the amount of the collected additional information and the information stored in the memory according to the size of the weight for each information, and input the information to the response model. The amount of information may mean the amount of information that is combined to generate a response. For example, when the response is generated, information having a small weight may have a small amount of information, and information having a large weight may have a large amount of information. That is, since there may be doubts about the reliability of the additional information acquired through the Internet, the reliability of the additionally acquired information may be calculated by comparing the additional information with the information stored in the memory through the existing supervised learning or unsupervised learning, and it may be determined whether to use the additional information when generating the response later. In addition, when reliability is high based on the reliability parameter (for example, the reliability parameter is equal to or greater than a threshold value), a response is generated by making additional information more basic than information previously stored in the memory at the time of generating the response later, and when the additional information is not reflected much, the reliability of the response may be increased by itself without reflecting the additional information much.

According to an embodiment, the model used by the electronic device 102 may be periodically evaluated to perform reinforcement learning, and may perform supervised learning using the basic pattern data. Referring back to FIG. 1, the model used by the electronic device 102 may be subjected to reinforcement learning periodically or aperiodically by the expert group 105. The expert group 105 may be a group of experts in the real world employed by the operator 104 that provides services of the present disclosure. For example, the expert group 105 may check whether the model is properly operated by learning the model once as initial data using supervised learning such as education, psychology, children, technology, public relations, economics, or the like, specialized books or digital data, and then frequently evaluating the model.

According to an embodiment, the response model may be built by response model building steps, the response model building steps may be executed through the processor of the electronic device, and the response model building steps may include a step of: calculating, by the processor 210, an accuracy parameter indicating an accuracy of a response generated for the request information of the user, converting the response into a natural language and outputting the converted response through an output means when the accuracy parameter is equal to or greater than a threshold value, and accessing the Internet through a network using a crawling model and collecting additional information when the accuracy parameter is less than the threshold value. The accuracy parameter may collectively refer to a parameter indicating the accuracy of the response. The accuracy parameter may be determined according to a degree of coincidence between information included in the response and information stored in the memory, and the degree of coincidence may have a value of 0 to 1. The present disclosure may have an effect of allowing the electronic device 102 to perform primary verification on the accuracy of the response generated by itself, so that when the response is not an appropriate response, additional information may be continuously obtained until an appropriate response is generated.

According to an embodiment, the crawling model may be built by crawling model building steps, the crawling model building steps may be executed through the processor of the electronic device, and the crawling model building steps may further include a step of: determining whether a cost is incurred in acquiring the additional information; determining whether to pay the cost based on the cost, the amount of the additional information, and whether the additional information can be acquired from the Internet through the network without the cost; and when it is determined to pay the cost, acquiring the additional information by performing payment. That is, the present disclosure may have an effect of preventing the occurrence of indiscriminate costs by allowing the electronic device 102 to autonomously determine whether collection of information incurring costs is necessary when crawling, or the like, incurring costs is performed.

The building of the response model may further include a step of: sensing a motion of the user and a facial expression with respect to the additional utterance through an image sensor, acquiring an image of the sensed motion of the user and facial expression, determining an emotion of the user by comparing the acquired image with images clustered for each emotion of the user stored in the memory, and calculating an appropriateness parameter indicating appropriateness of the additional utterance using the determined emotion, performing an additional dialog with respect to the additional utterance when the calculated appropriateness parameter is equal to or greater than a preset threshold value, and stopping the additional utterance when the calculated appropriateness parameter is less than the preset threshold value. As described above, the electronic device 102 of the present disclosure may perform a process of determining whether a response to the response considering the context information of the user is appropriate. It has the effect of being able to learn about the appropriateness of the response through the process of determining the appropriateness by itself. The appropriateness parameter may collectively refer to a parameter having a specific value that allows it to determine whether the response was appropriate. For example, when it is determined that the user's emotion is not good, the appropriateness parameter may have a low value, and when it is determined that the user's emotion is good, the appropriateness parameter may have a high value.

Those of ordinary skill in the art will appreciate that information and signals may be represented using any of a variety of different techniques and techniques. For example, data, instructions, commands, information, signals, bits, symbols, and chips that may be referenced in the description above may be represented by voltages, currents, electromagnetic waves, magnetic fields or particles, optical fields or particles, or any combination thereof.

Those of ordinary skill in the art will appreciate that the various illustrative logical blocks, modules, processors, means, circuits, and algorithm steps described in connection with the embodiments disclosed herein may be implemented by electronic hardware, various forms of program or design code (referred to herein, for convenience, as software), or a combination of both. To clearly illustrate this interchangeability of hardware and software, various illustrative components, blocks, modules, circuits and steps have been described generally above in relation to their functionality. Whether this functionality is implemented as hardware or software depends on the design constraints imposed on the particular application and the overall system. Those skilled in the art may implement the described functions in various ways for each particular application, but such implementation decisions should not be interpreted as deviating from the scope of the present disclosure.

The various embodiments presented herein may be implemented in a method, apparatus, or article of manufacture using standard programming and/or engineering techniques. The term article of manufacture includes a computer program, carrier, or media accessible from any computer-readable storage device. For example, computer-readable storage media include, but are not limited to, magnetic storage devices (e.g., hard disks, floppy disks, magnetic strips, etc.), optical disks (e.g., CDs, DVDs, etc.), smart cards, and flash memory devices (e.g., EEPROM, cards, sticks, key drives, etc.). Further, the various storage media presented herein include one or more devices and/or other machine-readable media for storing information.

It should be understood that the specific order or hierarchy of steps in the presented processes is an example of exemplary approaches. It should be understood that, based on design priorities, a particular order or hierarchy of steps in the processes may be rearranged within the scope of the present disclosure. The appended method claims provide the elements of the various steps in a sample order, but are not meant to be limited to the particular order or hierarchy presented.

The description of the embodiments presented is provided so that a person having ordinary skill in the art of any of the present disclosure may utilize or practice the present disclosure. Various modifications to these embodiments will be apparent to those of ordinary skill in the art, and the general principles defined herein can be applied to other embodiments without departing from the scope of the present disclosure. Thus, the present application is not limited to the embodiments set forth herein, but should be construed in the broadest range consistent with the principles and novel features set forth herein.

1. An interactive electronic device trained by a deep learning technique, the interactive electronic device comprising:
a memory;
a communication module;
an input means;
an output means; and
a processor configured to control the memory, the communication module, the input means, and the output means by using a model trained by the deep learning technique,
wherein the processor is configured to:
input an utterance from a user into a response possible determination model stored in the memory to determine whether it is possible to respond to the utterance of the user;
if it is possible to respond to the request information of the user, input the determination result into a response model stored in the memory to generate a response to the utterance and output the response through an output means;
if it is impossible to respond to the request information of the user, input the determination result into a crawling model stored in the memory to collect information associated with the request information of the user;
determine whether it is possible to respond to a user utterance based on the information collected by using the user utterance and the crawling model after collecting information related to user request information;
input the determination result to a response model stored in a memory, generate a response to the user utterance and output the response to the user utterance through an output means when it is possible to respond to the user request information;
collect information related to the user request information from a questionnaire by performing the questionnaire on the user when it is impossible to respond to the user request information;
after collecting information related to the user request information from the questionnaire by performing the questionnaire on the user, determine whether it is possible to respond to the user utterance based on the user utterance, the information collected by using the crawling model, and the information collected from the questionnaire;
when it is possible to respond to the user request information, input the determination result to a response model stored in the memory and generating a response to the utterance and outputting the response through the output means;
if it is impossible to respond to the request information of the user, collect information associated with the request information of the user from a survey by conducting a survey to the user;
collect information associated with the request information of the user from the survey by conducting the survey to the user;
determine whether it is possible to respond to the user's utterance based on the user's utterance, the information collected using the crawling model, and the information collected from the survey;
if it is possible to respond to the request information of the user, input the determination result to a response model stored in a memory, generate a response to the utterance, and output the response through an output means;
if it is impossible to respond to the request information of the user, transmit the information associated with the request information of the user to an expert terminal, collect response information, inputting the collected information to the response model, generate a response, and output the response through an output means; and
build the response possible determination model by response possible determination model build steps,
wherein the response possible determination model building steps are executed through the processor of the electronic device,
wherein the response possible determination model building steps include:
obtaining request information of a user from a natural language included in an utterance of the user obtained by using the input means; and
determining whether it is possible to respond to the request information of the user based on information stored in the memory,
wherein the response possible determination model building steps further include:
calculating a similarity between the user request information and information clustered and stored in the memory for each field to determine a field of the user request information; and
combining information included in the memory with respect to the determined field to determine whether to generate a response to the user request information, and determining whether additional information with respect to the field is required,
wherein the crawling model is built by crawling model building steps, the crawling model building steps being executed through the processor of the electronic device, and the crawling model building steps further include:
when the additional information is needed, accessing the Internet through a network and collecting the additional information;
comparing the collected additional information with information stored in the memory and calculating a reliability parameter for the collected additional information;
calculating a weight for each of the collected additional information and the information stored in the memory based on the reliability parameter; and
adjusting an amount of the collected additional information and the information stored in the memory according to a size of the weight for each information and inputting the adjusted amount to the response model,
wherein the crawling model is built by crawling model building steps, the crawling model building steps being executed through the processor of the electronic device, and the crawling model building steps include:
checking whether a cost is generated for acquiring the additional information;
determining whether to pay a cost based on the generated cost, an amount of the additional information, and whether the additional information can be acquired through the network without the cost generation; and
when it is determined to pay the cost, acquiring the additional information by performing a payment.

2. The electronic device of claim 1, wherein the response possible determination model, the response model, and the crawling model are periodically evaluated to perform reinforcement learning and to perform map learning using basic pattern data.

3. The electronic device of claim 1, wherein the response model is built by response model building steps,
wherein the response model building steps are executed through the processor of the electronic device, and wherein the response model building steps comprise:
calculating an accuracy parameter indicating an accuracy of a response generated for the user request information;
converting the response into a natural language and outputting the converted response through an output means when the accuracy parameter is equal to or greater than a threshold value; and
collecting additional information by accessing the Internet through a network using a crawling model when the accuracy parameter is less than the threshold value.

4. A method of operating an interactive electronic device trained by a deep learning technique comprising the steps of:
determining whether a response to a user's utterance is possible by inputting the utterance from the user to a response possible determination model stored in a memory;
generating a response to the utterance by inputting the determination result to a response model stored in the memory when the response to the user's request information is possible, and outputting the response to the utterance through an output means;
collecting information related to the user's request information by inputting the determination result to a crawling model stored in the memory when the response to the user's request information is impossible;
collecting the information related to the user's request information, and determining whether the response to the user's utterance is possible based on the user's utterance and the information collected by using the crawling model;
inputting the determination result to a response model stored in the memory when the response to the user's request information is possible, generating the response to the utterance,
and outputting the response through the output means;
collecting information related to user request information from a survey by conducting the survey with a user when the response to the user request information is not possible;
collecting information related to the user request information from the survey by conducting the survey with the user, and then determining whether the response to the user utterance is possible based on the user utterance, the information collected by using the crawling model, and the information collected from the survey;
inputting the determination result to a response model stored in a memory when the response to the user request information is possible, and generating and outputting the response to the utterance through an output means;
collecting response information by transmitting the information related to the user request information to an expert terminal when the response to the user request information is not possible; and
generating and outputting the response through an output means by inputting the collected information to the response model,
wherein the response possible determination model is built by response possible determination model building steps, the response possible determination model building steps are executed through a processor of the electronic device, and the response possible determination model building steps include:
obtaining request information of a user from a natural language included in an utterance of the user obtained by using an input means; and
determining whether a response to the request information of the user is possible based on information stored in the memory,
wherein the response possible determination model building steps further include:
calculating a similarity between the request information of the user and information clustered and stored in the memory for each field to determine a field of the request information of the user;
combining information included in the memory for the determined field to determine whether a response to the request information of the user can be generated, and determining whether additional information for the field is required,
wherein the crawling model is built by crawling model building steps, the crawling model building steps are executed through the processor of the electronic device, and the crawling model building steps further include:
when the additional information is required, accessing the Internet through a network to collect the additional information;
comparing the collected additional information with information stored in the memory to calculate a reliability parameter for the collected additional information;
calculating a weight for each of the collected additional information and the information stored in the memory, based on the reliability parameter; and
adjusting an amount of the collected additional information and the information stored in the memory according to a size of the weight for each information and inputting the adjusted amount to the response model,
wherein the crawling model building steps are built by crawling model building steps, and the crawling model building steps are executed through the processor of the electronic device, and the crawling model building steps further include:
determining whether a cost is incurred in acquiring the additional information;
determining whether to pay the cost based on the cost, an amount of the additional information, and whether the additional information can be acquired from the Internet through a network without the cost being incurred; and
acquiring the additional information by performing payment when it is determined to pay the cost.
